(19) United States
(12) Patent Application Publication
(10) Pub. No.: US 2008/0129922 A1
(43) Pub. Date: Jun. 5, 2008

(54) TRANSMISSION TYPE DISPLAY APPARATUS

(75) Inventors: Akiyoshi Kanemitsu, Niihama-shi (JP); Motohiro Yamahara, Nara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/938,934

(22) Filed: Nov. 13, 2007

(30) Foreign Application Priority Data
Nov. 13, 2006 (JP) 2006-306326

(51) Int. Cl. G02F 1/13357

(52) U.S. Cl. 349/62

(57) ABSTRACT

The present invention provides a transmission type display apparatus (4) capable of maintaining uniform and high luminance with a smaller number of light sources (21, 22, . . . ).

The transmission type display apparatus (4) of the present invention comprises a transmission type liquid crystal display panel (5) and a surface emission light source device (1) that illuminates the transmission type liquid crystal display panel (5) with illuminating light (F1) from behind thereof, wherein the surface emission light source device emits collimated light (F1) toward the front side in the normal direction (a) over the entire surface, and a light diffusing part (7) is disposed on the front side of the transmission type liquid crystal display panel (5) for transmitting incident light (F2), that enters on the back surface thereof, while diffusing the light (F2) isotropically.

### BACKGROUND OF THE INVENTION

1. Technical Field

The present invention relates to a transmission type display apparatus.

2. Description of the Related Art

Such a transmission type display apparatus (4′) is widely known, for example as shown in FIG. 7, that a surface emission light source device (1′) is disposed on the back side of a transmission type liquid crystal display panel (5), and one that isotropically emits illuminating light (F1′) toward the front surface is used as the surface emission light source device (1′) (refer to paragraph [0012] and FIG. 1 of patent document 1: Japanese Unexamined Patent Publication (Kokai) No. 7-141908).

However, the transmission type display apparatus (4′) of the prior art has such a problem that the contrast and hue of color picture vary significantly depending on whether it is viewed from the front or in an oblique direction.

To solve such a problem, it is proposed to combine a viewing angle compensation layer (not shown), that enables color picture to be seen in an oblique direction with comparable levels of contrast and hue to those of viewing from the front, and a transmission type liquid crystal display panel, but this is not necessarily a satisfactory solution.

### SUMMARY OF THE INVENTION

Accordingly, the present inventors have intensively studied so as to develop a transmission type display apparatus (4) that shows color pictures with similar contrast and hue regardless of whether it is viewed from the front or in an oblique direction, and thus the present invention has been completed.

The present invention provides a transmission type display apparatus (4) comprising a transmission type liquid crystal display panel (5) and a surface emission light source device (1) that illuminates the transmission type liquid crystal display panel (5) with illuminating light (F1) from behind thereof, wherein the surface emission light source device (1) emits collimated light (F1) toward the front side in a normal direction (a) over the entire surface, and a light diffusing part (7) is disposed on the front side of the transmission type liquid crystal display panel (5) for transmitting incident light (F2) that enters on the back surface while isotropically diffusing the light (F2) FIG. 1 schematically shows one example of the transmission type display apparatus (1) of the present invention.

The transmission type display apparatus (1) of the present invention shows color pictures with comparable levels of contrast and hue regardless of whether it is viewed from the front or in an oblique direction.

### BRIEF DESCRIPTION OF THE DRAWINGS

FIG. 1 is a sectional view schematically showing an example of the transmission type display apparatus (4) of the present invention.

FIG. 2 is a sectional view schematically showing the deflection plate (3) and the light sources (21, 22, . . . ) in the first embodiment of the surface emission light source device (1).

FIG. 3 is a sectional view schematically showing the deflection plate (3) in the first embodiment of the surface emission light source device (1).

FIG. 4 is a sectional view schematically showing the deflection plate (3) and the light sources (21, 22, . . . ) in the first embodiment of the surface emission light source device (1).

FIG. 5 is a sectional view schematically showing the deflection plate (3) in the first embodiment of the surface emission light source device (1).

FIG. 6 is a diagram schematically showing the direction in which luminance of light (F1) emitted from the surface emission light source device (1) is measured.

FIG. 7 is a sectional view schematically showing an example of the transmission type display apparatus (4′) of the prior art.

### BRIEF DESCRIPTION OF THE REFERENCE SYMBOLS

1: Surface emission light source device
21, 22, . . . : Light sources
L: Distance between light sources
F11, F12, . . . : Light from light sources
F1: Collimated light
F1′: Illuminating light
F2: Incident light
3: Deflection plate
a: Normal line
A0, A1, A2, . . . A29: Regions
d: Distance between light source and deflection plate
αn, βn: Angles which two oblique sides form with the normal line (a)
4: Transmission type display apparatus
5: Transmission type liquid crystal display panel
51: Liquid crystal layer
52: Back-side polarizer
53: Front-side polarizer
54: Liquid crystal cell
55: Transparent electrode
56: Transparent electrode
6: Lamp box
7: Light diffusing part

### DETAILED DESCRIPTION OF THE INVENTION

The transmission type display apparatus (4) of the present invention shown in FIG. 1 comprises the transmission type liquid crystal display panel (5), the surface emission light source device (1) and the light diffusing part (7).

The transmission type liquid crystal display panel (5) displays color pictures, and comprises, for example as shown in FIG. 1, a liquid crystal cell (54) and a pair of polarizers (52, 53) respectively disposed on the front side and back side of the liquid crystal cell (54).

The liquid crystal cell (54) comprises a liquid crystal layer (51) formed from a liquid crystal material and a pair of transparent electrodes (55, 56) respectively disposed on the front side and back side of the liquid crystal layer (51).

The liquid crystal material that constitutes the liquid crystal layer (51) may have either positive or negative anisotropy in dielectric constant. The liquid crystal material of the liquid crystal layer (51) may be aligned either in a direction parallel or perpendicular to the transparent electrode when no voltage is applied across the transparent electrode plates (55, 56).

In a liquid crystal display panel (5) of TN (twisted nematic) mode, STN (super twisted nematic) mode or n cell mode, a liquid crystal material having positive anisotropy in dielectric constant is aligned parallel to the transparent electrode when no voltage is applied across the transparent electrodes (55, 56).

In a liquid crystal display panel (5) of VA (vertical alignment) mode, the liquid crystal material having positive anisotropy in dielectric constant is aligned perpendicular to the transparent electrode when no voltage is applied across the transparent electrodes (55, 56).

The liquid crystal material that constitutes the liquid crystal layer (51) changes the direction of alignment when a voltage is applied across the transparent electrode plates (55, 56) that are disposed on both sides thereof.

The polarizers (52, 53) disposed on the front side and back side of the liquid crystal cell (54) allow a component of light transmitting therethrough that is polarized in a plane parallel to the transmission axis of the polarizers (52, 53) with the plane of vibration remaining the same, but shuts off the component having plane of vibration perpendicular to the polarizing direction, and may be formed from, for example, a polyvinyl alcohol film with a dichromatic material such as iodine applied thereon in an aligned configuration. The polarizers (52, 53) are normally used with a support plate (not shown) made of a transparent resin such as triacetyl cellulose (TAC) attached to one or both sides thereof.

The liquid crystal display panel (5) may have a color filter (not shown). Providing a color filter enables the displaying of color pictures. The color filter may be disposed on the back side of the back-side polarizer (52), between the back-side polarizer (51) and the back-side transparent electrode (55), between the front-side transparent electrode (56) and the front-side polarizer (53), or on the front side of the front-side polarizer (53).

The liquid crystal display panel (5) may have a contrast compensation layer (not shown) for the purpose of improving the contrast and hue when viewed from the front. The contrast compensation layer may be formed from a uniaxially stretched film of polycarbonate in the case where the liquid crystal display panel (5) is of STN mode, or a biaxially stretched film of a cycloolefin resin in the case where the liquid crystal display panel (5) is of IPS mode.

The surface emission light source device (1) emits collimated light (F1) toward the front side in the normal direction (a) over the entire surface, and comprises, for example as shown in FIG. 1, a plurality of light sources (21, 22, . . . ) disposed while being separated by a space (L) from each other within a plane, and a deflection plate (3) is disposed in front of the plurality of light sources (21, 22, . . . ) for changing the direction of lights (F11, F12, . . . ) from the plurality of light sources (21, 22, . . . ), and the deflection plate (3) is configured so as to direct the lights (F11, F12) from two adjacent light sources (21, 22) among the plurality of light sources (21, 22, . . . ) in the normal direction (a) toward the front surface over the entire surface between the light sources (21, 22)

The surface emission light source device (1) comprises rod-shaped light sources (21, 22, . . . ) disposed at equal intervals (L) within a plane. The space (L) between the light sources (21, 22, . . . ) is ordinarily in a range from 15 mm to 150 mm. For the light sources (21, 22, . . . ), for example, light sources of straight tube construction such as fluorescent lamps (cold cathode ray tubes), or point light sources such as LEDs may be used.

The plurality of light sources (21, 22, . . . ) is disposed in a lamp box (6). The lamp box (6) ordinarily has reflecting surface on the inside thereof.

The deflection plate (3) is provided on the front side of the plurality of light sources (21, 22, . . . ). The deflection plate (3) is normally constituted from a plate made of a transparent material, such as a transparent resin or a transparent glass.

The transparent resin may be a polycarbonate resin, an ABS resin (acrylonitrile-styrene-butadiene copolymer resin), a methacrylate resin, a PMMA resin (polymethyl methacrylate resin), a MS resin (methyl methacrylate-styrene copolymer resin), a polystyrene resin, an AS resin (acrylonitrile-styrene copolymer resin), or a polyolefin resin such as polyethylene or polypropylene. The deflection plate (3) may contain a light diffusing material dispersed therein.

The thickness of the deflection plate (3) is ordinarily from 0.1 mm to 15 mm, preferably from 0.5 mm to 10 mm, and more preferably from 1 mm to 5 mm.

The deflection plate (3) is ordinarily disposed so as to cover all of the light sources (21, 22). A distance (d) between the light sources (21, 22, . . . ) and the deflection plate (3) is ordinarily from 5 mm to 50 mm.

The deflection plate (3) is constituted so as to direct the lights (F1, F12) emitted by the two light sources (21, 22) toward the front side in the normal direction (a) over the entire surface between the two adjacent light sources (21, 22).

### FIRST EMBODIMENT

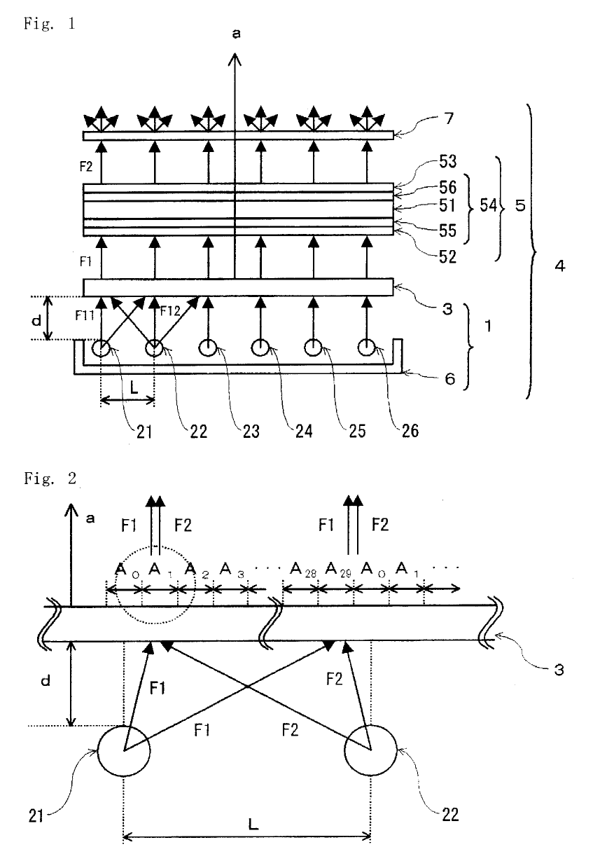

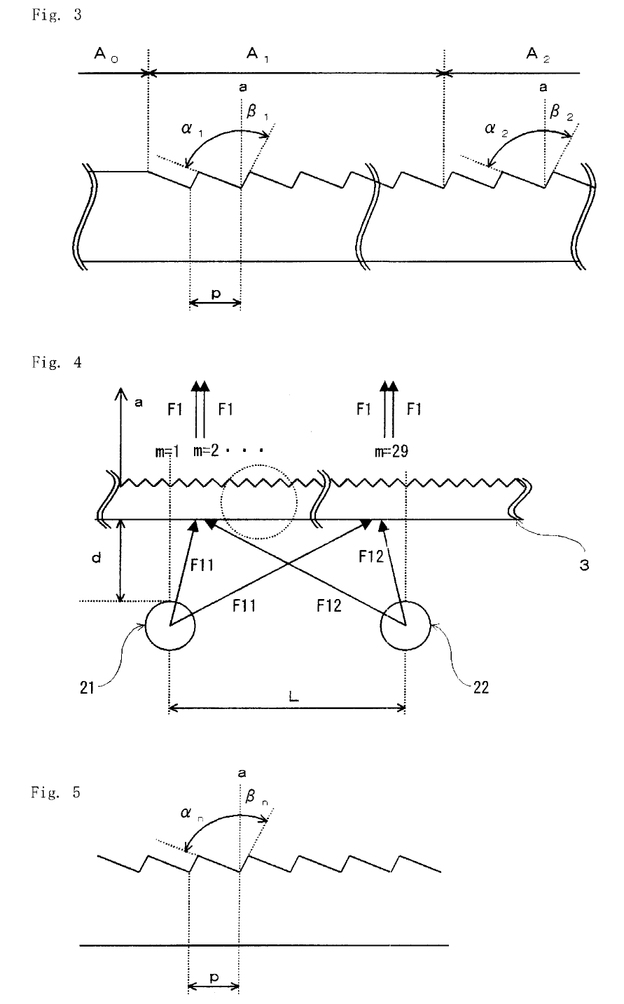

FIGS. 2 and 3 schematically show a first embodiment of the deflection plate (3) that constitutes the surface emission light source device (1). The surface emission light source device (1) that employs the deflection plate (3) is constituted from a plurality of fluorescent lamps (21, 22, . . . ) as the light sources disposed at intervals (L) of 30 mm. The deflection plate (3) is disposed at a distance (d) of 21 mm from the fluorescent lamps (21, 22, . . . ). The deflection plate (3) is formed from a transparent resin having a refractive index of 1.57 at a thickness of 2 mm.

The deflection plate (3) is flat all over the surface thereof whereon the light enters, namely the surface on the light source side, as shown in FIG. 2.

The deflection plate (3) is divided into 30 regions (Am, m=0, 1, 2, . . . 29) in the space between the two adjacent light sources (21, 22). Each region Am is 1,000 μm (1 mm) in length.

As shown in FIG. 3, the light emerging surface is flat in the region (A0 (m=0)) located in the vicinity of the two light sources (21, 22), and light emitted by the light sources (21, 22) located right below thereof is directed directly toward the front surface in the normal direction (a) of the deflection plate (3).

In the 29 regions (Am, m=1, 2, . . . 29) in the space between the two adjacent light sources (21, 22), the light emerging surface of the deflection plate (3) is constituted from prisms each having the same triangular cross section. Each of the regions (A1, A2, . . . A29) includes 20 prisms which are disposed at intervals (p) of 50 μm. In each of the regions (A1, A2, . . . A29), two oblique sides of the triangular cross sections of the prisms form angles (αn, βn) with the normal line (a) as shown in Table 1.

TABLE 1

| n | αn(°) | βn(°) |
|---|---|---|
| 1 | 85.1 | 24.2 |
| 2 | 80.5 | 24.8 |
| 3 | 76.1 | 25.4 |
| 4 | 72.0 | 26.1 |
| 5 | 68.0 | 26.8 |
| 6 | 64.4 | 27.7 |
| 7 | 60.9 | 28.6 |
| 8 | 57.6 | 29.6 |
| 9 | 54.5 | 30.7 |
| 10 | 51.7 | 32.0 |
| 11 | 49.0 | 33.3 |
| 12 | 46.5 | 34.7 |
| 13 | 44.1 | 36.3 |
| 14 | 41.9 | 38.1 |
| 15 | 39.9 | 39.9 |
| 16 | 38.1 | 41.9 |
| 17 | 36.3 | 44.1 |
| 18 | 34.7 | 46.5 |
| 19 | 33.3 | 49.0 |
| 20 | 32.0 | 51.7 |
| 21 | 30.7 | 54.5 |
| 22 | 29.6 | 57.6 |
| 23 | 28.6 | 60.9 |
| 24 | 27.7 | 64.4 |
| 25 | 26.8 | 68.0 |
| 26 | 26.1 | 72.0 |
| 27 | 25.4 | 76.1 |
| 28 | 24.8 | 80.5 |
| 29 | 24.2 | 85.1 |

In all of the regions (A1, A2, . . . , A29) located in the space between the two light sources (21, 22), the lights (F11, F12) from the two light sources (21, 22) emit toward the front side in the normal direction (a) of the deflection plate (3) as collimated light (F1).

### SECOND EMBODIMENT

FIGS. 4 and 5 schematically show a second embodiment of the deflection plate (3). The surface emission light source device (1) that employs the deflection plate (3) is constituted from a plurality of fluorescent lamps (21, 22, . . . ) as the light sources disposed at intervals (L) of 30 mm. The deflection plate (3) is disposed at a distance (d) of 21 mm from the fluorescent lamps (21, 22). The deflection plate (3) is formed from a transparent resin having a refractive index of 1.49 at a thickness of 2 mm.

The deflection plate (3) is flat all over the surface thereof whereon the light enters, namely the surface on the light source side, as shown in FIG. 4.

In the space between the two adjacent light sources (21, 22), the light emerging surface of the deflection plate (3) is constituted from 29 prisms each having the same triangular cross section as shown in FIG. 5, while two oblique sides of the triangular cross sections of the prisms form angles (αn, βn, n=1, 2, . . . 29) with the normal line (a) shown in Table 2.

TABLE 2

| n | αn(°) | βn(°) |
|---|---|---|
| 1 | 84.4 | 19.2 |
| 2 | 79.1 | 19.7 |
| 3 | 74.1 | 20.3 |
| 4 | 69.5 | 20.9 |
| 5 | 65.1 | 21.6 |
| 6 | 60.9 | 22.3 |
| 7 | 57.1 | 23.2 |
| 8 | 53.4 | 24.1 |
| 9 | 50.1 | 25.2 |
| 10 | 46.9 | 26.4 |
| 11 | 44.0 | 27.7 |
| 12 | 41.3 | 29.2 |
| 13 | 38.8 | 30.8 |
| 14 | 36.6 | 32.5 |
| 15 | 34.4 | 34.4 |
| 16 | 32.5 | 36.6 |
| 17 | 30.8 | 38.8 |
| 18 | 29.2 | 41.3 |
| 19 | 27.7 | 44.0 |
| 20 | 26.4 | 46.9 |
| 21 | 25.2 | 50.1 |
| 22 | 24.1 | 53.4 |
| 23 | 23.2 | 57.1 |
| 24 | 22.3 | 60.9 |
| 25 | 21.6 | 65.1 |
| 26 | 20.9 | 69.5 |
| 27 | 20.3 | 74.1 |
| 28 | 19.7 | 79.1 |
| 29 | 19.2 | 84.4 |

The prisms make it possible to direct the lights (F11, F12) from the two light sources (21, 22) toward the front side in the normal direction (a) of the deflection plate (3) as collimated light (F1), over the entire region between the two light sources (21, 22).

### THIRD EMBODIMENT

As a third embodiment, reference is made to such a constitution as 599 prisms each having a triangular cross section are disposed on the light emerging surface between the two adjacent light sources (21, 22) in the deflection plate (3) shown in FIG. 4 and FIG. 5. The angles (αn, βn: n=1, . . . 529) which two oblique sides of the triangular cross sections of the prisms form with the normal line (a) are calculated by equations (1) and (2).

αn(∘)=−1.50×10⁻⁷×n³+3.23×10⁻⁴×n²−0.2503×n+90 (1)

βn(∘)=−1.50×10⁻⁷×(600−n)³+3.23×10⁻⁴×(600−n)²−0.2503×(600−n)+90 (2)

The prisms make it possible to direct the lights (F11, F12) from the two light sources (21, 22) toward the front side in the normal direction (a) of the deflection plate (3) as collimated light (F1), over the entire region between two light sources (21, 22).

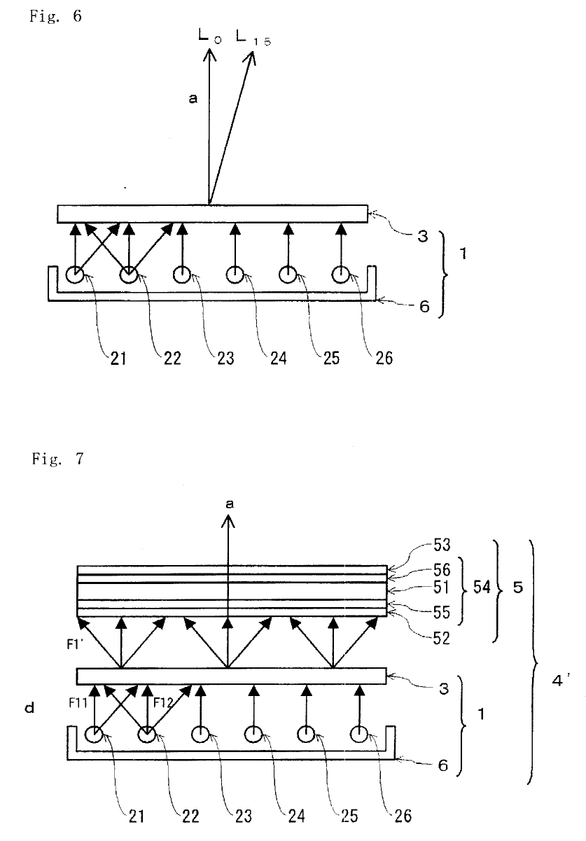

Collimated light (F1) emitted by the surface emission light source device (1) having such luminance over the entire surface of the surface emission light source device (1) as a luminance (L₀) observed in the normal direction (a) as shown in FIG. 6 and a luminance (L₁₅) observed in a direction at an angle of 15 degrees from the normal direction (a) satisfy the relation (1).

L₀/2≧L₁₅ (1)

The surface emission light source device (1) is disposed on the back side of the transmission type liquid crystal display panel (5).

The light diffusing part (7) that constitutes the transmission type display apparatus (4) of the present invention is an optical component that transmits the incident light (F2) while diffusing the light (F2) isotropically.

The light diffusing part (7) may be, for example, a light diffuser plate that is formed by uniformly dispersing a light diffusing material in a transparent material. The transparent material may be a methacrylate resin, a polycarbonate resin, a styrene resin, a methylmethacrylate-styrene copolymer resin, a polypropylene resin or the like. The light diffusing material may be particles having a refractive index different from that of the transparent material.

The light diffusing part (7) may also be a light diffuser plate that is formed by mixing thermoplastic materials which have different refractive indices and are not mutually soluble, and after molding the mixed material into a plate in the molten state, cooling the same.

The light diffusing part (7) may also be a light diffuser plate that has such a constitution as fine matted surface on a plate formed from a transparent material. The fine matted surface may be formed on the transparent plate, for example, by sand blasting the surface of the transparent plate so as to roughen the surface by powdered abrasive material, by applying a paint including fine particles onto the surface of a transparent plate so as to form bumps from the fine particles, or forming microlens array or microprism array on the surface by a machining process.

The light diffusing part (7) is disposed on the front side of the transmission type liquid crystal display panel (5), for example, on the front side of the front-side polarizer (53) that is disposed on the front side of the liquid crystal cell (54) that constitutes the transmission type liquid crystal display panel (5).

In the case where a color filter is disposed on the front side of the front-side polarizer (53), the light diffusing part (7) may also perform the function of the color filter. In the case where a support plate is provided on the front side of the front-side polarizer (53), the light diffusing part (7) may also serve as the support plate.

In the transmission type display apparatus (4) of the present invention, since the transmission type liquid crystal display panel (5) is illuminated by the collimated light (F1) emitted by the surface emission light source device (1) toward the front side in the normal direction (a), a picture formed by the transmission type display apparatus (5) emits light constituted from collimated light (F1) toward the front side in the normal direction (a) over the entire surface so as to enter the light diffusing part (7). Since the collimated light (F1) entering the light diffusing part (7) enter the light diffusing part (7) while being diffused isotropically, the transmission type display apparatus (4) of the present invention makes it possible to view color pictures with similar contrast and hue regardless of whether it is viewed from the front or in an oblique direction.

As a result, the transmission type display apparatus (4) of the present invention is capable of showing pictures with similar contrast and hue regardless of whether it is viewed from the front or in an oblique direction, without using the viewing angle compensation layer that is used to show a picture with similar contrast and hue regardless of whether it is viewed from the front or in an oblique direction in the transmission type display apparatus (4′) of the prior art that employs the surface emission light source device (1′) that isotropically transmits illumination light (F1′) toward the front surface.

For the viewing angle compensation layer, for example, WV Film (manufactured by FUJIFILM Corporation) used in combination with a liquid crystal display panel of TN mode, LC Film (manufactured by Nippon Oil Corporation) used in combination with a liquid crystal display panel of STN mode, a biaxial retardation film used in combination with a liquid crystal display panel of IPS mode, a retardation plate that combines an A plate and a C plate used in combination with a liquid crystal display panel of VA mode, or WV Film for OCB (manufactured by FUJIFILM Corporation) used in combination with a liquid crystal display panel of n cell mode may be used.

What is claimed is:

1. A transmission type display apparatus (4) comprising a transmission type liquid crystal display panel (5) and a surface emission light source device (1) that illuminates the transmission type liquid crystal display panel (5) with illuminating light (F1) from behind thereof, wherein the surface emission light source device (1) emits collimated light (F1) toward the front side in the normal direction (a) over the entire surface, and a light diffusing part (7) is disposed on the front side of the transmission type liquid crystal display panel (5) for transmitting incident light (F2) entering on the back surface while isotropically diffusing the light (F2).

2. The transmission type display apparatus (4) according to claim 1, wherein the surface emission light source device (1) comprises a plurality of light sources (21, 22, . . . ) disposed within a plane while being separated by a space (L) from each other, and a deflection plate (3) is disposed in front of the plurality of light sources (21, 22, . . . ) for changing the direction of lights (F11, F12, . . . ) from the plurality of light sources 21, 22, . . . ), and the deflection plate (3) is configured to direct the lights (F11, F12) from two adjacent light sources (21, 22) among the plurality of light sources (21, 22, . . . ) in a normal direction (a) toward the front surface over the entire surface between the two light sources (21, 22).
